(19) United States
(12) Patent Application Publication
(10) Pub. No.: US 2016/0286390 A1
(43) Pub. Date: Sep. 29, 2016

(54) FLEXIBLE AND SECURE NETWORK MANAGEMENT

(71) Applicant: QUALCOMM Incorporated, San Diego, CA (US)

(72) Inventors: Olivier Jean Benoit, San Diego, CA (US); Peerapol Tinnakornsrisuphap, San Diego, CA (US)

(21) Appl. No.: 15/055,840

(22) Filed: Feb. 29, 2016

Related U.S. Application Data
(60) Provisional application No. 62/139,489, filed on Mar. 27, 2015.

(51) Int. Cl. H04W 12/04; H04L 9/32; H04L 29/06

(52) U.S. Cl. CPC H04W 12/04; H04L 63/0428; H04L 9/3263; H04W 84/12

(57) ABSTRACT

An apparatus and method for configuring access points and wireless devices for use within a wireless local area network (WLAN) is disclosed. In at least one exemplary embodiment, a network manager may obtain the public keys of an access point and the wireless devices to be included in the WLAN. The network manager may generate and provide a public key list including the public keys of the wireless devices to the access point. The access point may establish communication links with the wireless devices corresponding to the public keys in the public key list. The network manager may generate a de-authorization list that includes the public keys of access points no longer authorized to operate within the WLAN. The de-authorization list may be distributed to wireless devices within the WLAN. The wireless devices may refuse connections to access points listed on the de-authorization list.

### CROSS-REFERENCE TO RELATED APPLICATION

This application claims priority to U.S. Provisional Patent Application No. 62/139,489 entitled “FLEXIBLE AND SECURE NETWORK MANAGEMENT” filed Mar. 27, 2015, the entirety of which is incorporated by reference herein.

### TECHNICAL FIELD

The example embodiments relate generally to communication systems, and specifically to managing wireless device access within wireless networks.

### BACKGROUND OF RELATED ART

A wireless local area network (WLAN) may be formed by one or more access points (APs) that provide a shared wireless communication medium for use by a number of wireless (e.g., client) devices. Each AP, which may correspond to a Basic Service Set (BSS), periodically broadcasts beacon frames to enable any client devices within wireless range of the AP to establish and/or maintain a communication link (e.g., a communication channel) with the WLAN.

In some WLANs, a first AP may be configured for use with one or more client devices via a common password or passphrase. For example, a password or passphrase may be entered (programmed) into the first AP. The client devices must then use the same password or passphrase to access the WLAN through the first AP. Adding a second AP to the WLAN may be a straightforward task by simply entering the current password or passphrase into the second AP. In contrast, securely removing the first AP from service may be difficult. For example, to de-authorize the first AP, the password or passphrase may be changed and entered into all the client devices as well as the second AP. Although the process of changing the password or passphrase may be time consuming and error prone, retaining the old password or passphrase may allow the WLAN to be easily compromised.

Accordingly, it is desirable to improve the management and configuration of the APs of the WLAN.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

In some aspects, a method of configuring an access point for use in a wireless network is disclosed. In accordance with example embodiments, a network manager may determine a public key of the access point and generate an access point certificate based, at least in part, on the public key of the access point. The network manager may transmit the access point certificate to the access point to establish communications between the access point and a plurality of wireless devices.

In another aspect, a wireless device is disclosed that may include a transceiver, a processor and a memory to store instructions that, when executed by the processor, causes the wireless device to: determine a public key of the access point, generate an access point certificate based, at least in part, on the public key of the access point, and transmit the access point certificate to the access point to establish communications between the access point and a plurality of wireless devices.

### BRIEF DESCRIPTION OF THE DRAWINGS

The example embodiments are illustrated by way of example and are not intended to be limited by the figures of the accompanying drawings.

FIG. 1 is a block diagram of a wireless system within which the example embodiments may be implemented.

FIG. 2 shows an illustrative flow chart depicting an example operation for configuring the access point and the client devices for use within the wireless local area network of FIG. 1 in accordance with example embodiments.

FIG. 3 is a block diagram of a wireless system within which example embodiments may be implemented.

FIG. 4 shows an illustrative flow chart depicting an example operation for adding an additional access point to the wireless local area network of FIG. 3, in accordance with example embodiments.

FIG. 5 shows an example wireless device that may be an embodiment of the access point, the client devices, and/or the smartphone of FIG. 1.

Like reference numerals refer to corresponding parts throughout the drawing figures.

### DETAILED DESCRIPTION

The example embodiments are described below in the context of WLAN systems for simplicity only. It is to be understood that the example embodiments are equally applicable to other wireless networks (e.g., cellular networks, pico networks, femto networks, satellite networks), as well as for systems using signals of one or more wired standards or protocols (e.g., Ethernet and/or HomePlug/PLC standards). As used herein, the terms “WLAN” and “Wi-Fi®” may include communications governed by the IEEE 802.11 family of standards, Bluetooth, HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including one or more APs and a number of client devices, the example embodiments are equally applicable to other WLAN systems including, for example, multiple WLANs, peer-to-peer (or Independent Basic Service Set) systems, Wi-Fi Direct systems, and/or Hotspots.

In the following description, numerous specific details are set forth such as examples of specific components, circuits, and processes to provide a thorough understanding of the present disclosure. The term “coupled” as used herein means connected directly to or connected through one or more intervening components or circuits.

In addition, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. The example embodiments are not to be construed as limited to specific examples described herein but rather to include within their scopes all embodiments defined by the appended claims.

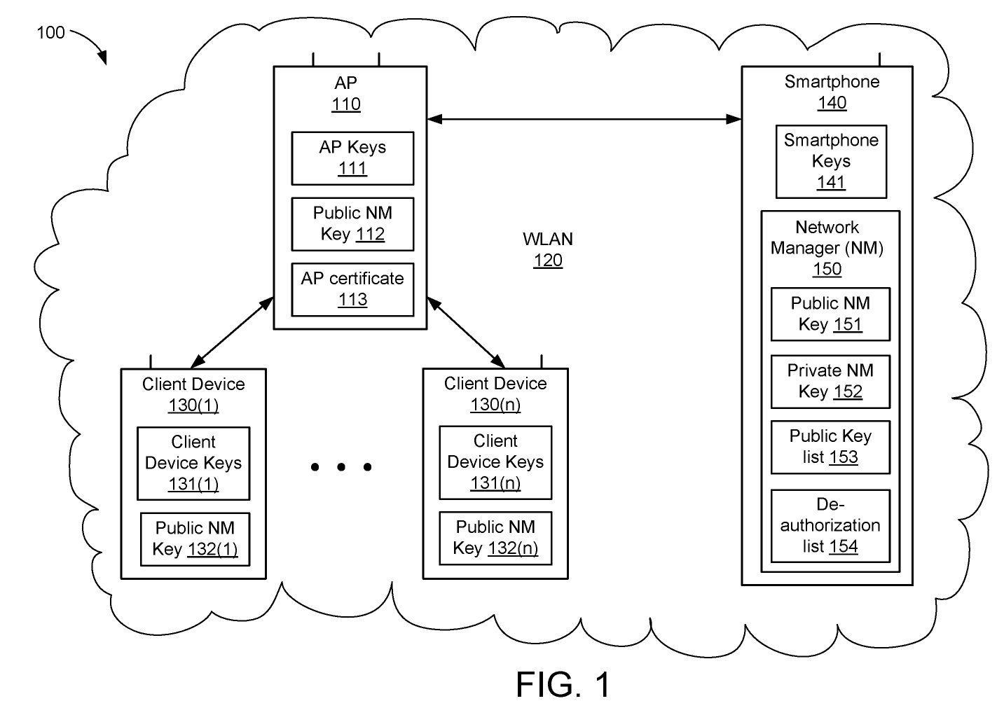

FIG. 1 is a block diagram of a wireless system 100 within which the example embodiments may be implemented. The wireless system 100 may include an access point (AP) 110, a number of client devices 130(1)-130(n), a smartphone 140, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that the WLAN 120 may be formed by any number of access points such as the AP 110. For some embodiments, the wireless system 100 may correspond to a single user multiple-input multiple-output (SU-MIMO) or a multi-user MIMO (MU-MIMO) wireless network. Further, although the WLAN 120 is depicted in FIG. 1 as an infrastructure BSS, for other example embodiments, the WLAN 120 may be an IBSS, an ad-hoc network, or a peer-to-peer (P2P) network (e.g., operating according to Wi-Fi Direct protocols).

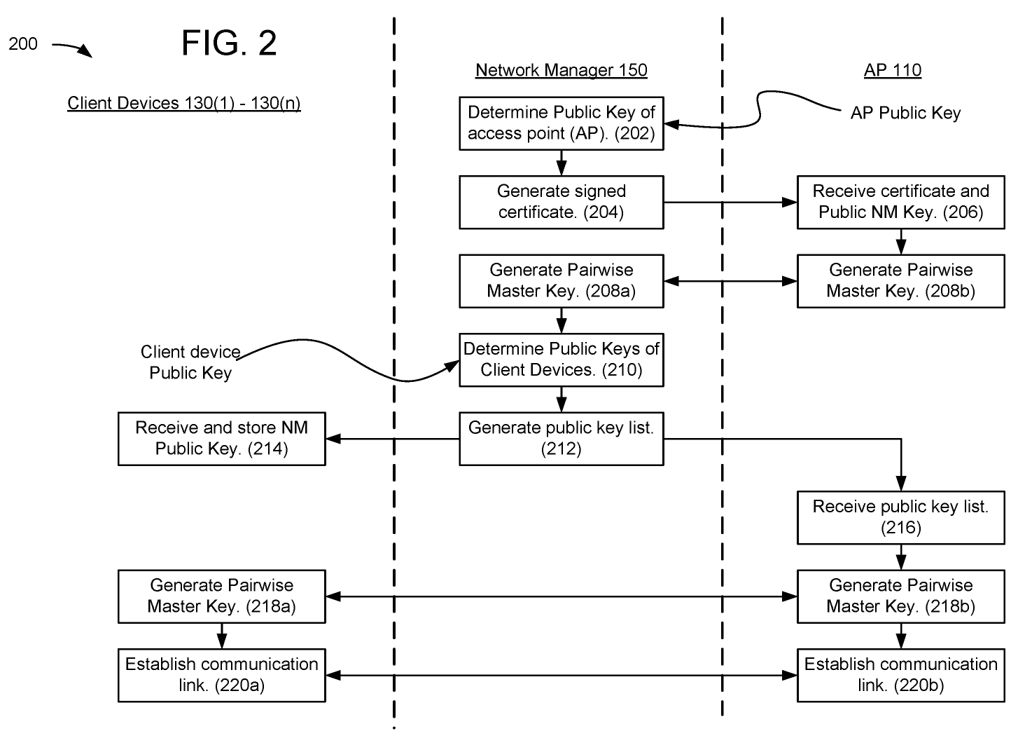

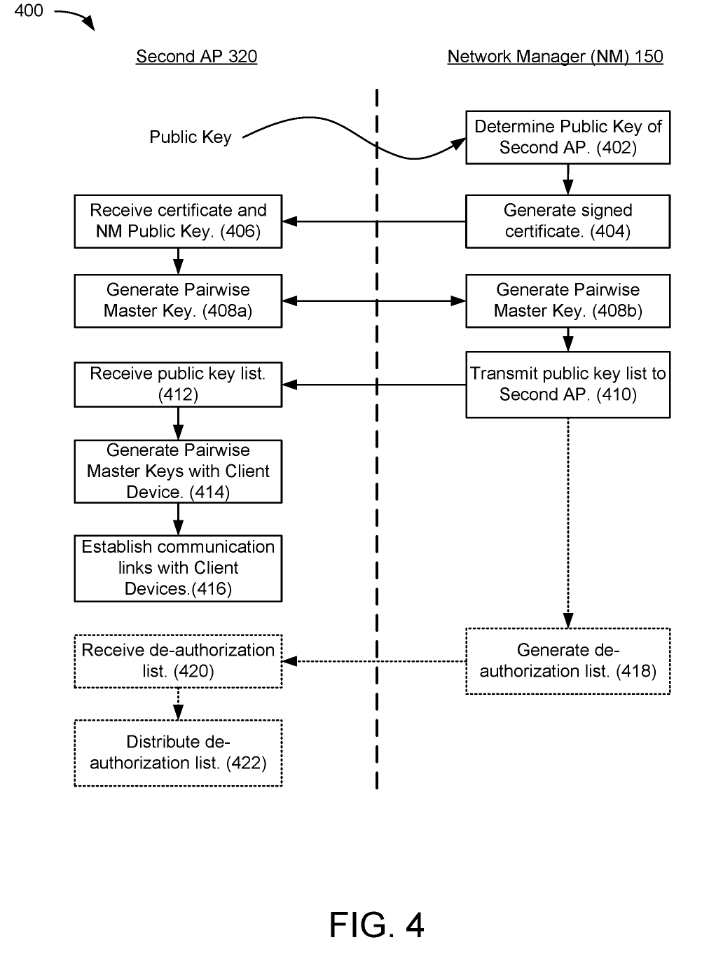

Each of the client devices 130(1)-130(n) and the smartphone 140 may be any suitable Wi-Fi enabled wireless device including, for example, a cell phone, personal digital assistant (PDA), tablet device, laptop computer, or the like. Each client device 130 and/or the smartphone 140 may also be referred to as a user equipment (UE), a subscriber station, a mobile unit, a subscriber unit, a wireless unit, a remote unit, a mobile device, a wireless communications device, a remote device, a mobile subscriber station, an access terminal, a mobile terminal, a wireless terminal, a remote terminal, a handset, a user agent, a mobile client, a client, or some other suitable terminology. For some embodiments, the client device 130 and/or the smartphone 140 may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 2 and 4.

The AP 110 may be any suitable device that allows one or more wireless devices to connect to a network (e.g., a local area network (LAN), wide area network (WAN), metropolitan area network (MAN), and/or the Internet) via the AP 110 using Wi-Fi, Bluetooth, or any other suitable wireless communication standards. For at least one embodiment, the AP 110 may include one or more transceivers, one or more processing resources (e.g., processors and/or ASICs), one or more memory resources, and a power source. In some embodiments, the AP 110 may also be any suitable Wi-Fi and network enabled device including, for example, a cell phone, PDA, tablet device, laptop computer, or the like. The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 2 and 4.

For the AP 110, the client devices 130(1)-130(n), and the smartphone 140, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the included transceivers may be any technically feasible transceiver such as a ZigBee transceiver described by a specification from the ZigBee specification, a WiGig transceiver, and/or a HomePlug transceiver described a specification from the HomePlug Alliance.

Before any one of the client devices 130(1)-130(n) can access any services and/or networks through the AP 110, the client devices 130(1)-130(n) and the AP 110 may be configured to communicate through one or more secure communication links. In some embodiments, a network manager 150 may aid and/or initiate the configuration of the AP 110 and the client devices 130(1)-130(n). In the example of FIG. 1, the network manager 150 is included in the smartphone 140. In other embodiments, the network manager 150 may be included in other wireless devices (not shown for simplicity) that may have access to (e.g., a connection to) the AP 110.

Each wireless device may have a public/private key pair. In some embodiments, the public/private key pair may be a Root Identity key pair (sometimes referred to as an identity key pair) and may be assigned (e.g., programmed) into a wireless device during manufacture. In other embodiments, the public/private key pair may be dynamically generated. For example, a wireless device may use a random number generator and/or may receive a random number seed to generate the public/private key pair.

For example, the AP 110 may include AP keys 111, client devices 130(1)-130(n) may include client device keys 131(1)-131(n) respectively, and the smartphone 140 may include smartphone keys 141. The AP keys 111 may include a public/private key pair of the AP 110, the smartphone keys 141 may include a public/private key pair of the smartphone 140, and the client device keys 131(1)-131(n) may include a public/private key pair of the respective client devices 130(1)-130(n). In addition, the network manager 150 may include a public Network Manager (NM) key 151 and a private NM key 152.

The network manager 150 may administer the WLAN 120 by generating signed certificates and distributing public keys associated with the wireless devices. The signed certificates and public keys may be used to establish secure communication links between the AP 110 and the client devices 130(1)-130(n). In some embodiments, the secure communication links may use public/private key encryption. Those skilled in the art will appreciate that public/private key encryption techniques may encrypt and decrypt messages between wireless devices such as the client devices 130(1)-130(n) and the AP 110. In some embodiments, other security mechanisms may be used in addition to, or alternately from the public/private key encryption described herein.

Configuration of the AP 110 may begin as the network manager 150 determines the public key of the AP 110. In some embodiments, the public key of the AP 110 may be determined in an out-of-band manner. For example, the smartphone 140 may include an optical device (e.g., camera) to scan labels and/or images. The AP 110 may include a label imprinted with a quick response (QR) code that may display the public key or may direct a scanning device to retrieve the public key from a remote device or service. Thus, the QR code may directly or indirectly provide the public key of the AP 110 to the network manager 150.

In other embodiments, other out-of-band methods may determine the public key of the AP 110. For example, a near field communication (NFC) link or a Bluetooth Low Energy (BLE) link may convey the public key of the AP 110 to the smartphone 140. Although only NFC links and BLE communication links are described herein, any other technically feasible communication link may be used.

The network manager 150 may generate an AP certificate 113 based, at least in part, on the public key of the AP 110. The AP certificate 113 may be signed with the private NM key 152. The signed AP certificate 113 may be provided to the AP 110 along with the public NM key 151. Thus, the AP 110 may store the public NM key 151 (as the public NM key 112) and the signed AP certificate 113. The AP 110 and the network manager 150 may establish a secure communication link based, at least in part, on the public NM key 151, the private NM key 152, and the AP certificate 113.

In parallel to, or in series with the configuration of the AP 110, the network manager 150 may determine the public keys of the client devices 130(1)-130(n). In some embodiments, the public keys may be also be determined in an out-of-band manner similar to as described above with respect to the AP 110. The network manager 150 may generate a public key list 153. The public key list 153 may include the public keys of the client devices 130(1)-130(n) and may be certified by the private NM key 152. The network manager 150 may provide the public key list 153 to the AP 110. The network manager 150 may also provide each client device 130(1)-130(n) with a copy of the public NM key 151 (stored as the public NM keys 132(1)-132(n)), respectively.

The AP 110 may use the public key list 153 to establish communication links between the AP 110 and each client device 130(1)-130(n). For example, the AP 110 may verify the public key list 153 using the public NM key 112. If the public key list 153 is verified, then the AP 110 may contact the client devices 130(1)-130(n) based on the public key list 153 and the AP 110 may present the AP certificate 113. The client devices 130(1)-130(n) may verify the AP certificate 113 and generate a shared Pairwise Master Key with each client device 130(1)-130(n) to establish a secure communications link. Thus, the AP 110 forms communication links based, at least in part, on the public key list 153.

Additional APs may be added to the WLAN 120 in a similar manner as described above with respect to the AP 110. To remove and/or de-authorize an AP, the network manager 150 may generate a de-authorization list 154. The de-authorization list 154 may include the public keys of the APs no longer permitted to function (e.g., denied to operate) within the WLAN 120. The de-authorization list 154 may be certified with the private NM key 152. The network manager 150 may provide the de-authorization list 154 to the AP 110. The AP 110 may verify and then distribute the de-authorization list 154 to the client devices 130(1)-130(n). Thereafter, connections and/or communications with APs included within the de-authorization list 154 are discontinued. Operations associated with configuring the WLAN 120 via the network manager 150 are described in more detail below in conjunction with FIG. 2.

FIG. 2 shows an illustrative flow chart 200 depicting an example operation for configuring the AP 110 and the client devices 130(1)-130(n) for use within the WLAN 120, in accordance with example embodiments. Some embodiments may perform the operations described herein with additional operations, fewer operations, operations in a different order, operations in parallel, and/or some operations differently. To ease the explanation of the operations depicted in FIG. 2, some elements from FIG. 1, although not illustrated in FIG.2, are described herein with the corresponding reference numbers from FIG. 1. The operations depicted in FIG. 2 may correspond to an initial configuration of the AP 110 and the client devices 130(1)-130(n). Furthermore, in the example of FIG. 2, the network manager 150 is included within the smartphone 140. In other embodiments, the network manager 150 may be included in other wireless devices such as the client devices 130(1)-130(n) or the AP 110. Referring also to FIG. 1, the operation begins as the network manager 150 determines a public key of the AP 110 (202). In some embodiments, the public key of the AP 110 may be part of a Root Identity key pair or part of a dynamically generated public/private key pair associated with the AP 110. Further, the public key may be determined in an out-of-band manner. In some embodiments, the out-of-band manner may have a relatively short communication range. The short communication range may ensure that the determined public key is associated with the AP 110 and not other wireless devices.

Next, the network manager 150 generates a signed AP certificate 113 based, at least in part, on the public key of the AP 110 (204). The AP certificate 113 may be signed with the private NM key 152. Next, the AP 110 receives the AP certificate 113 and the public NM key 151 (206). The AP certificate 113 may be presented to wireless devices as proof that the AP 110 is authorized to operate within the WLAN 120 by the network manager 150. The public NM key 151 may verify data, certificates, and/or lists provided by the network manager 150 or other wireless devices.

Next, the AP 110 and the network manager 150 generate a shared Pairwise Master Key (208a and 208b). For example, the network manager 150 and the AP 110 may exchange one or more messages using the public NM key 151 and the public key of the AP 110 to generate the shared Pairwise Master Key. In some embodiments, the AP 110 and the network manager 150 may use a well-known 4-way handshake algorithm to generate the shared Pairwise Master Key. The Pairwise Master Key may be used to establish a secure communication link between the AP 110 and the network manager 150.

Next, the network manager 150 determines the public keys of the client devices 130(1)-130(n) (210). The public keys of the client devices 130(1)-130(n) may be determined in an out-of-band manner as described above with respect to the AP 110. Next, the network manager 150 generates the public key list 153 (212). The public key list 153 may include the public keys of the client devices 130(1)-130(n). In some embodiments, the public key list 153 is signed by the private NM key 152.

Next, the client devices 130(1)-130(n) receive and store the public NM key 151 from the network manager 150 (214). As described above, the client devices 130(1)-130(n) may use the public NM key 151 to verify data, certificates, and/or lists received from other wireless devices. For example, the client devices 130(1)-130(n) may use the public NM key 151 to verify the AP certificate 113 signed with the private NM key 152. If the AP certificate 113 is successfully verified, then the information contained in the certificate may be trusted.

Next, the AP 110 receives the public key list 153 from the network manager 150 (216). The AP 110 may use the public keys in the public key list 153 to contact the client devices 130(1)-130(n). The public key list 153 may be transmitted and received through an encrypted communication link based, at least in part, on the Pairwise Master Key. Next, the AP 110 and each of the client devices 130(1)-130(n) generate a shared Pairwise Master key (218a and 218b). Each client device 130(1)-130(n) may be associated with a distinct Pairwise Master Key. In some embodiments, the AP 110 may transmit the public key of the AP 110 to the client devices 130(1)-130(n). The public key of the AP 110 may be signed with the private NM key 152. The client devices 130(1)-130(n) may verify the public key of the AP 110 with the public NM keys 132(1)-132(n). The Pairwise Master Key may be generated if the public key of the AP 110 is successfully verified. Next, the AP 110 and the client devices 130(1)-130(n) establish communication links using the shared Pairwise Master Key (220a and 220b).

In the example of FIG. 2, operations (202)-(208a and 208b) are performed before operations (210)-(216). In other embodiments, operations (210)-(216) may be performed before or in parallel with operations (202)-(208a and 208b).

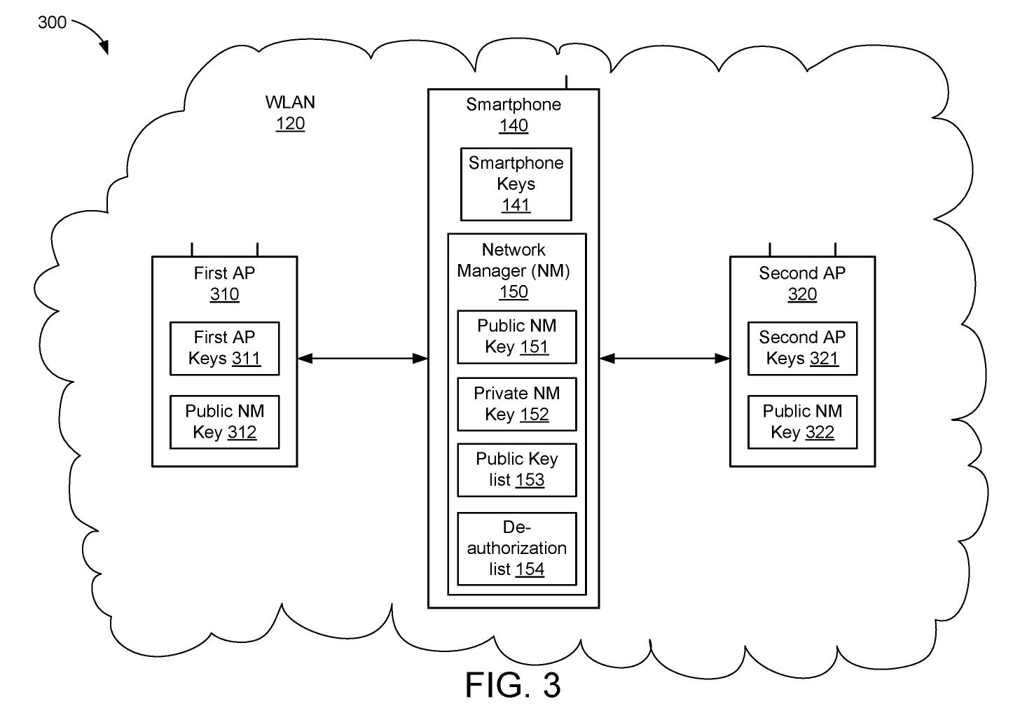

FIG. 3 is a block diagram of a wireless system 300 within which the example embodiments may be implemented. The wireless system 300 may include a first AP 310, a second AP 320, the smartphone 140 (as described above with respect to FIGS. 1 and 2), and the WLAN 120. The first AP 310 and the second AP 320 may be embodiments of the AP 110 of FIG. 1. The WLAN 120 may also include one or more client devices 130(1)-130(n), not shown for simplicity. The first AP 310 may be configured as described above with respect to the AP 110 of FIG. 2. Therefore, the first AP 310 may include first AP keys 311 (e.g., a public/private key pair of the first AP 310) and a public NM key 312. The public NM key 312 may be a copy of the public NM key 151.

The second AP 320 may be added to the WLAN 120 by the network manager 150 in a similar manner as the first AP 310. The second AP 320 may include second AP keys 321 (e.g., a private/public key pair of the second AP 320). As the second AP 320 is configured to operate within the WLAN 120, the second AP 320 may store a copy of the public NM key 151 as a public NM key 322.

To de-authorize (e.g., remove from service) an AP from the WLAN 120, the network manager 150 may generate the de-authorization list 154. The de-authorization list 154 may include the public keys of the APs to de-authorize. The de-authorization list 154 may be distributed to wireless devices within the WLAN 120. The wireless devices may refuse connections to APs listed on the de-authorization list 154. Operations associated with adding the second AP 320 to the WLAN 120 and de-authorizing APs are described in more detail below in conjunction with FIG. 4.

FIG. 4 shows an illustrative flow chart 400 depicting an example operation for adding an additional AP to the WLAN 120, in accordance with example embodiments. To ease the explanation of the operations depicted in FIG. 4, some elements from FIG. 1, although not illustrated in FIG.4, are described herein with the corresponding reference numbers from FIG. 1. Referring also to FIG. 3, the operation begins as the network manager 150 determines a public key of the second AP 320 (402). In some embodiments, the public key of the second AP 320 may be part of a Root Identity Key pair associated with the second AP 320. In other embodiments, the public key may be dynamically generated. Further, the public key may be determined in an out-of-band manner.

Next, the network manager 150 generates a second AP certificate based, at least in part, on the public key of the second AP 320 (404). The second AP certificate may be distinct from the AP certificate 113 described above with respect to FIGS. 1 and 2. The second AP certificate may be signed with the private NM key 152. Next, the second AP 320 receives the second AP certificate and the public NM key 151 (406). The public NM key 151 may verify certificates, other data, and/or lists provided by the network manager 150 or other wireless devices.

Next the second AP 320 and the network manager 150 generate a shared Pairwise Master Key (408a and 408b). For example, the network manager 150 and the second AP 320 may exchange one or more messages using the public NM key 151 and the public key of the second AP 320 to generate the shared Pairwise Master Key. The Pairwise Master Key may be used to establish a secure communication link between the second AP 320 and the network manager 150.

Next, the network manager 150 transmits the public key list 153 to the second AP 320 (410). As described above with respect to FIG. 2, the public key list 153 may be signed with the private NM key 152. Next, the second AP 320 receives the public key list 153 from the network manager 150 (412). The second AP 320 may verify the public key list 153 with the public NM key 151. The second AP 320 may contact the client devices 130(1)-130(n) based, at least in part, on the public key list 153.

Next, the second AP 320 and the client devices 130(1)-130(n) generate a shared Pairwise Master key (414). In some embodiments, the second AP 320 may present the second AP certificate to the client devices 130(1)-130(n) to prove that the second AP 320 is authorized to operate within the WLAN 120. The Pairwise Master Key may be generated if the second AP certificate is successfully verified. Next, the second AP 320 and the client devices 130(1)-130(n) establish communication links using the shared Pairwise Master key (416).

In some embodiments, one or more of the APs operating within the WLAN 120 may optionally be removed from service. For example, a new AP may be replacing an older AP; therefore, the older AP may be removed from the WLAN 120. The APs to be removed from service (e.g., de-authorized) may be identified by their associated public key. The optional operations are illustrated with dotted lines in FIG. 4.

Operations to de-authorize one or more APs begin as the network manager 150 generates the de-authorization list 154 (418). The de-authorization list 154 may include the public AP keys corresponding to the APs that are to be removed from service. The de-authorization list 154 may be signed with the private NM key 152. The de-authorization list 154 may be transmitted to the second AP 320.

Next the second AP 320 may receive the de-authorization list 154 (420). The de-authorization list 154 may be verified with the public NM key 151 previously received by the second AP 320. The second AP 320 may block communications to APs that correspond to the public AP keys included in the de-authorization list 154. Next, the second AP 320 distributes the de-authorization list to the client devices 130(1)-130(n) (422). The client devices 130(1)-130(n) may also verify the de-authorization list 154 and block communications to the APs that correspond to the public AP keys included in the de-authorization list 154.

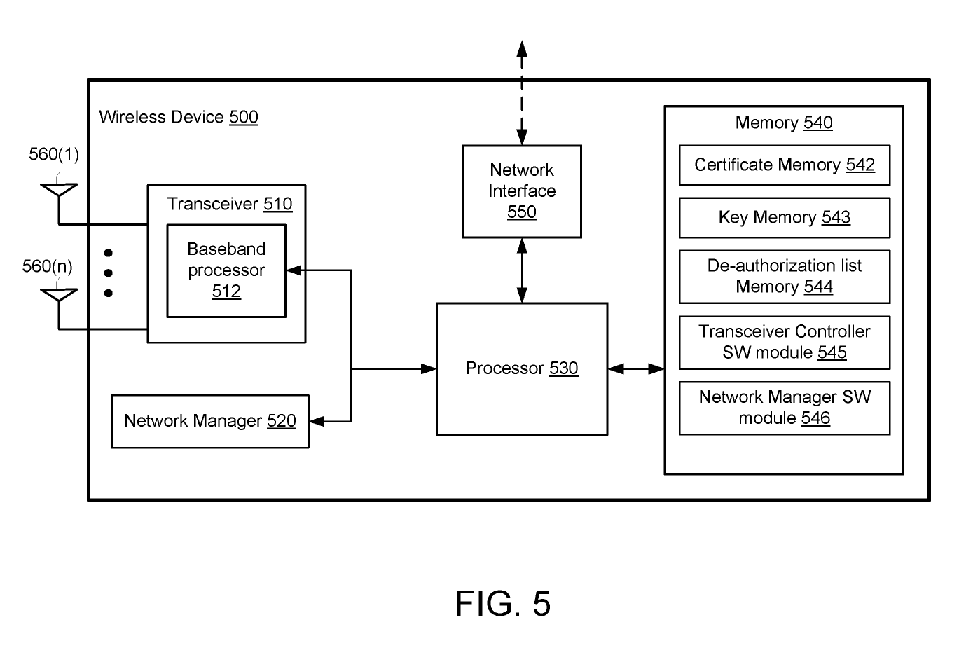

FIG. 5 shows an example wireless device 500 that may be an embodiment of the AP 110, the client devices 130(1)-130(n), and/or the smartphone 140 of FIG. 1. The wireless device 500 may include a transceiver 510, a network manager 520, a processor 530, a memory 540, a network interface 550, and a number of antennas 560(1)-560(n). The network manager 520 may be an embodiment of the network manager 150 of FIG. 1. The transceiver 510 may be coupled to antennas 560(1)-560(n), either directly or through an antenna selection circuit (not shown for simplicity). The transceiver 510 may communicate wirelessly with one or more client devices, with one or more other APs, and/or with other suitable wireless devices. Although not shown in FIG. 5 for simplicity, the transceiver 510 may include any number of transmit chains to process and transmit signals to other wireless devices via antennas 560(1)-560(n), and may include any number of receive chains to process signals received from antennas 560(1)-560(n). Thus, for example embodiments, the wireless device 500 may be configured for MIMO operations including, for example, SU-MIMO operations and MU-MIMO operations.

The transceiver 510 may include a baseband processor 512. The baseband processor 512 may process signals received from the processor 530 and/or the memory 540 and to transmit the processed signals via one or more of antennas 560(1)-560(n). Additionally, the baseband processor 512 may process signals received from one or more of antennas 560(1)-560(n) and forward the processed signals to the processor 530 and/or the memory 540.

The network interface 550 may access other networks and/or services. In some embodiments, the network interface 550 may include a wired interface. The network interface 550 may also communicate with a WLAN server (not shown for simplicity) either directly or via one or more intervening networks.

The processor 530, which is coupled to the transceiver 510, the network manager 520, the network interface 550, and the memory 540, may be any suitable one or more processors capable of executing scripts or instructions of one or more software programs stored in the wireless device 500 (e.g., within the memory 540). For actual embodiments, the transceiver 510, the processor 530, the memory 540, and/or the network interface 550 may be connected together using one or more buses (not shown for simplicity).

The memory 540 may include a certificate memory 542 to store certificates (e.g., the AP certificate 113). In some embodiments the certificates may be generated by the network manager 520 and/or a network manager software module 546 (described below).

The memory 540 may include a key memory 543 to store public, private, and/or shared keys. For example public and private keys associated with the wireless device 500 (e.g., a public/private key pair and/or a Pairwise Master Key) may be stored in the key memory 543. In some embodiments, the key memory 543 may store the public NM key 151 and the private NM key 152 (not shown for simplicity). In some embodiments, increased protection may be provided to the key memory 543 to safeguard sensitive keys, such as the private NM key 152.

The memory 540 may include a de-authorization list memory 544. The de-authorization list memory 544 may store the de-authorization list 154 (not shown for simplicity). In some embodiments, the de-authorization list 154 may be generated by the network manager 520 and certified by the private NM key 152.

The memory 540 may also include a non-transitory computer-readable medium (e.g., one or more nonvolatile memory elements, such as EPROM, EEPROM, Flash memory, a hard drive, and so on) that may store at least the following software (SW) modules:
a transceiver controller software module 545 to transmit and receive wireless data through the transceiver 510; and
a network manager software module 546 to perform operations associated with the network manager 520.
   Each software module includes instructions that, when executed by the processor 530, cause the wireless device 500 to perform the corresponding functions. Thus, the non-transitory computer-readable medium of the memory 540 includes instructions for performing all or a portion of the operations depicted in FIGS. 2 and 4.

As mentioned above, the processor 530 may be any suitable one or more processors capable of executing scripts or instructions of one or more software programs stored in the wireless device 500 (e.g., within the memory 540). For example, the processor 530 may execute the transceiver controller software module 545 to facilitate the transmission and/or reception of data between the wireless device 500 and other wireless devices (not shown for simplicity).

The processor 530 may execute the network manager software module 546 to determine public keys associated with APs (e.g., the AP 110, the first AP 310, and/or the second AP 320) and/or the client devices 130(1)-130(n) (not shown for simplicity). The network manager software module 546 may also generate certificates (e.g., the AP certificate 113) and may sign the certificates with the private NM key 152. Further, the network manager software module 546 may generate the public key list 153 and the de-authorization list 154.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences, or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example embodiments have been described with reference to specific example embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of configuring an access point (AP) for use in a wireless network, the method comprising:
determining, by a network manager, a public key of the AP;
generating an AP certificate based, at least in part, on the public key of the AP; and
transmitting the AP certificate to the AP to establish communications between the AP and a plurality of wireless devices.

2. The method of claim 1, wherein the public key is a public root identity key programmed into the AP when the AP is manufactured.

3. The method of claim 1, wherein the AP certificate is signed via a private network manager key.

4. The method of claim 1, further comprising:
determining, by the network manager, public keys of the plurality of wireless devices.

5. The method of claim 4, wherein the public keys are dynamically generated by the wireless devices.

6. The method of claim 4, further comprising:
generating a public key list based, at least in part, on the public keys of the plurality of wireless devices.

7. The method of claim 6, further comprising:
transmitting the public key list to the AP.

8. The method of claim 7, wherein the public key list is transmitted through an encrypted communication link.

9. The method of claim 6, wherein the public key list is signed by a private network manager key.

10. The method of claim 6, further comprising:
contacting the wireless devices based, at least in part, on the public key list.

11. The method of claim 1, further comprising:
generating, by the network manager, a de-authorization list of public keys corresponding to APs denied operation within the wireless network.

12. The method of claim 11, wherein the de-authorization list is signed by a private network manager key.

13. The method of claim 11, further comprising:
distributing the de-authorization list to APs and wireless devices within the wireless network.

14. A wireless device comprising:
a transceiver;
a processor; and
a memory storing instructions that when executed by the processor cause the wireless device to:
determine a public key of an access point (AP);
generate an AP certificate based, at least in part, on the public key of the AP; and
transmit the AP certificate to the AP to establish communications between the AP and a plurality of wireless devices.

15. The wireless device of claim 14, wherein execution of the instructions cause the wireless device to further:
determine public keys of the plurality of wireless devices; and
generate a public key list based, at least in part, on the public keys of the plurality of wireless devices.

16. The wireless device of claim 15, wherein execution of the instructions cause the wireless device to further:
contact wireless devices based, at least in part, on the public key list.

17. The wireless device of claim 14, wherein execution of the instructions cause the wireless device to further:
generate a de-authorization list of public keys corresponding to APs denied operation within a wireless network.

18. The wireless device of claim 17, wherein the de-authorization list is signed by a private network manager key.

19. The wireless device of claim 17, wherein execution of the instructions cause the wireless device to further:
distribute the de-authorization list to APs and wireless devices within the wireless network.

20. A wireless device comprising:
means for determining a public key of an access point (AP);
means for generating an AP certificate based, at least in part, on the public key of the AP; and
means for transmitting the AP certificate to the AP to establish communications between the AP and a plurality of wireless devices.

21. The wireless device of claim 20, further comprising:
means for determining public keys of the plurality of wireless devices; and
means for generating a public key list based, at least in part, on the public keys of the plurality of wireless devices.

22. The wireless device of claim 21, further comprising:
means for contacting wireless devices based, at least in part, on the public key list.

23. The wireless device of claim 20, further comprising:
means for generating a de-authorization list of public keys corresponding to APs denied operation within a wireless network.

24. The wireless device of claim 23, wherein the de-authorization list is signed by a private network manager key.

25. The wireless device of claim 23, further comprising:
means for distributing the de-authorization list to APs and wireless devices within the wireless network.

26. A non-transitory computer-readable medium storing instructions that, when executed by a processor of a wireless device, causes the wireless device to:
determine a public key of an access point (AP);
generate an AP certificate based, at least in part, on the public key of the AP; and
transmit the AP certificate to the AP to establish communications between the AP and a plurality of wireless devices.

27. The non-transitory computer-readable medium of claim 26, wherein execution of the instructions cause the wireless device to:
determine public keys of the plurality of wireless devices; and
generate a public key list based, at least in part, on the public keys of the plurality of wireless devices.

28. The non-transitory computer-readable medium of claim 26 wherein execution of the instructions cause the wireless device to:
generate a de-authorization list of public keys corresponding to APs denied operation within a wireless network.

29. The non-transitory computer-readable medium of claim 28, wherein the de-authorization list is signed by a private network manager key.

30. The non-transitory computer-readable medium of claim 28, wherein execution of the instructions cause the wireless device to:
distribute the de-authorization list to APs and wireless devices within the wireless network.
